(19) United States
(12) Patent Application Publication
(10) Pub. No.: US 2012/0159611 A1
(43) Pub. Date: Jun. 21, 2012

(54) Central Administration and Abstraction of Licensed Software Features

(75) Inventor: Jacob Andrew Stearns, Bee Cave, TX (US)

(73) Assignee: Neopost Technologies, Bagneux (FR)

(21) Appl. No.: 12/968,531

(22) Filed: Dec. 15, 2010

(51) Int. Cl. G06F 21/22

(52) U.S. Cl. 726/18

(57) ABSTRACT

Systems and techniques are provided to allow for license abstraction by a central licensing server among a set of remote clients. The central server may generate a configuration file that can be pushed to remote clients, to configure the clients to provide desired software features. The licensed features may be distributed among the clients in any combination desired by an administrator.

### BACKGROUND OF THE INVENTION

License management arrangements have been developed to protect software revenue from erosion resulting from unauthorized software use or access. In some cases, software licenses can be centrally managed, such as by using a license server that provides software access to remote clients according to terms of a particular license negotiated between the software developer and the user. In some arrangements, granularity of license management extends to feature management.

Present license management arrangements use a “pull” relationship between clients and their license management servers—that is, the clients are informed with respect to available applications and features therein, and make explicit requests for access to them. Available licenses are then transferred from the server to the corresponding clients, at which point the clients are able to use the licensed software or features. For example, in some arrangements each client has a list of available software packages within the enterprise. Upon identifying a need for a particular package, the client requests a license for that package from the central server. The central server verifies that a license is available and, if so, provides it to the client. The server also may provide a license key, installer, or other component necessary for the client to use the licensed package. Some arrangements may provide for return of the license key or other component to the server so that it may be available to fulfill other client requests. Other present remote configuration arrangements may include those where potential configuration(s) for a particular client are defined in advance, and are allowed in accordance with existing license agreements.

Use of such arrangements limits flexibility, and often are limited to a particular number of seats, a number of concurrently-running instances of the software, and other similar restrictions. For example, a user with a high priority need for a software application or feature may find that the application or feature is unavailable when the need is urgent. Accordingly, it would be desirable to have a configuration arrangement that overcomes at least some of these drawbacks.

### BRIEF SUMMARY OF THE INVENTION

The invention provides advantageous methods and systems for managing software features and licenses. The methods and systems may allow for pushing licenses for software and/or software features to remote clients. Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

In an embodiment, a method of managing software features is provided. The method includes receiving a first software license that defines rights for a first licensed software package at a central license abstraction server, and generating, in response to an instruction from a license administrator, a first configuration file that defines a first set of features allowed for client use, including features available in the first licensed software package. The first configuration file may be pushed from the central license abstraction server to the plurality of remote clients, thereby providing the first set of features to users of the remote clients. In response to an instruction from a license administrator, a second configuration file that defines a second set of features including features available in the first licensed software package, may be generated and pushed to the remote clients. The total features defined by the first and second sets of features may not extend beyond the terms of the first license.

In an embodiment, a method of managing software features is provided. The method includes receiving a first software license that defines rights for a first licensed software package at a central license abstraction server. The method further includes generating a first configuration defining a first set of features that includes features available in the first licensed software package allowed for client use. In response to an instruction from a license administrator, the first configuration file may be pushed from the central license abstraction server to the first remote client, thereby causing the first remote client to provide the first set of features to a user of the first remote client

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and various ways in which it may be practiced.

FIG. 1 shows an example license management system that allows for license abstraction and client configuration according to an embodiment of the invention.

FIG. 2 shows an example client license interface according to an embodiment of the invention.

FIG. 3 shows a hierarchical system for license abstraction and management according to an embodiment of the invention.

FIG. 4 shows an example license abstraction technique according to an embodiment of the invention.

FIG. 5 shows a computer suitable for use with embodiments of the present invention.

FIG. 6 shows a schematic diagram of a processing unit suitable for use with embodiments of the present invention.

FIG. 7 shows an example of a computer network suitable for use with the present invention.

### DETAILED DESCRIPTION OF THE INVENTION

As described above, present license management arrangements utilize a client/server structure that depends upon a “pull” relationship in which clients are fully informed of available applications and features, and make explicit requests for access to them. It has been found that such arrangements are not suitable for use in many systems, such as where a greater degree of administrative control is desired or required by licensing terms.

In embodiments of the present invention, one or more software licenses reside, and may remain, solely on an administrative server or servers. In accordance with the appropriate license terms, a server may administer and dynamically reconfigure remote clients to have access to or implement licensed software packages, or features of licensed software. The administration may be performed by one or more administrators, such as via a graphical supervisory interface. The supervisory interface can be deployed in a tiered manner. For example, systems according to embodiments of the invention may include a hierarchy of supervisors and/or supervisory servers, with each supervisor being able to configure the licenses available to other lower supervisors in the hierarchy. This provides flexibility, and also changes the general topology from a traditional client request/server response to one where each client transparently alters its behavior in response to being instructed or configured by an administrator, thus removing control over licensed software and features from client operators. Each client may be configured individually, or a template may be used to arrange multiple clients in a similar or identical configuration. For example, a particular client's configuration can be taken as a “snapshot” to act as a profile template for re-use with other clients. This may further simplify the administrative process for large scale deployments. The profile may be tied to a particular computer, user account, user type, or similar restriction.

After a configuration is set at the administrative level, it may be is “pushed” from the server to one or more clients, each of which may be a computer, user profile, or some combination thereof. As used herein, a “push” system is one in which the initial request for data transfer is initiated by the server, as opposed to the client(s). Such “push” systems are distinguished from typical “pull” systems, in which each client requests data from a server, and the server does not provide data until requested. A “push” system is characterized by the client receiving appropriate configuration information from the server before configuring available software and/or features. Once each client is updated, it may then reconfigure the available features as defined by the configuration data obtained from the administrative server.

In an embodiment, client configuration may be separated from license management. This separation allows additional flexibility, since the configuration is not directly tied to any specific license vendor, and the underlying licensing mechanisms may be replaced with no knowledge of the client systems deployed. For example, each client or business location may have a separate licensing system, while still allowing for consolidated feature configuration and administration.

In various embodiments, individual clients may have no advance knowledge of the potential configurations available from the licensing server. For example, in the “push” systems described herein, a central administrator can confirm availability of necessary features and a client need not formulate a request for a particular software package or feature. In such arrangements, the client does not need full knowledge of available software or features within the system other than those already installed and available at the client.

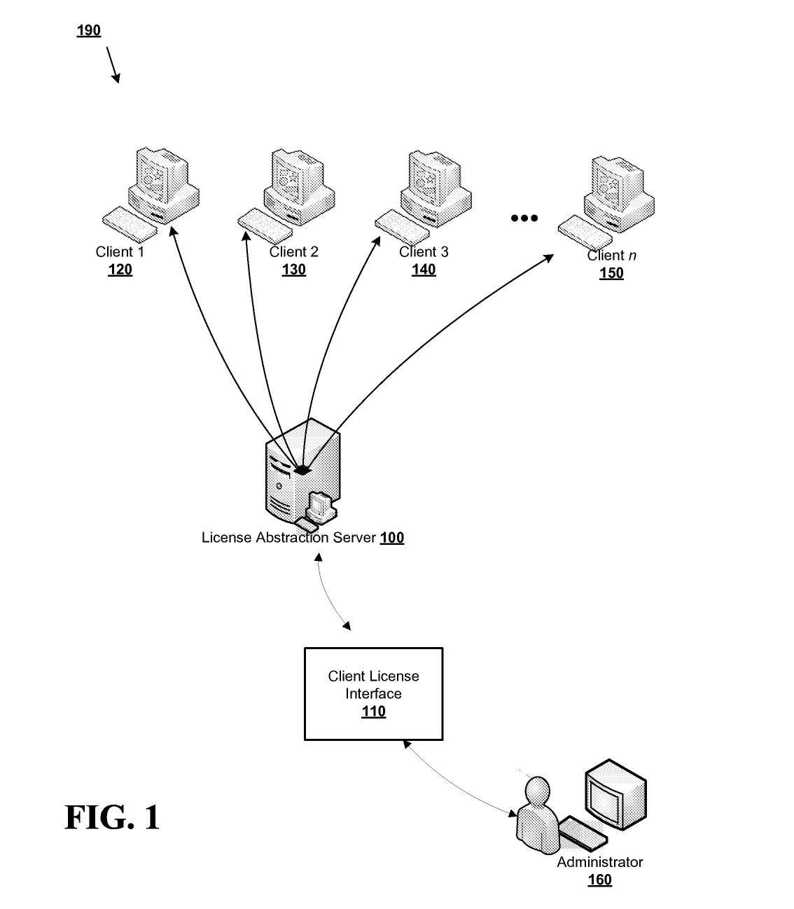

FIG. 1 shows an example license management system 190 at a “location” that allows for license abstraction and client configuration. The system 190 may include multiple clients 120-150, which may be separate physical computers, logical computers such as virtualized environments, user accounts that configure software on each computer upon successful log-in of a user, or any other similar client device or structure. As used herein, reference number 150 may generally represent one or more of the clients 120-150, and the term location may represent one or more computers that are grouped based upon having one or more of functional, physical, or logical traits in common. A license abstraction server 100 may store one or more software licenses for licensed software packages. As will be understood by one of skill in the art, a software license defines the legal rights that a client 150 has with respect to the licensed software package. For example, a software license may define the number of concurrent users of the software package, the specific features available for use, the expiration of the license and rights defined therein, the number of installations allowed, and similar rights. The abstraction server 100 provides an administrative client license interface 110 that allows an administrator 160 to specify which software packages and/or features are to be installed or otherwise made available to users of remote clients 150. In general, the abstraction server 100 may manage an arbitrary number of licenses for an arbitrary number of clients 150.

The license server 100 may be referred to as an “abstraction” server because it may allow an administrator to abstract out the features in licensed software packages, and provide them to clients in arbitrary combinations. For example, a software package may include five separately-usable components or features, which typically would be licensed and provided as a complete package to a single client 150 or enterprise. The license abstraction server 100 may allow the administrator 160 to define configuration files that specify different combinations of those features for different clients, such as installing each feature on one of five clients 150, installing two features on one client 120 and three on the other 130, only installing a single feature on one client 120, and so on. The initial license(s) managed by the server 100 may be received from a third-party license management system, and/or another license abstraction server in a hierarchical system, as described in further detail below.

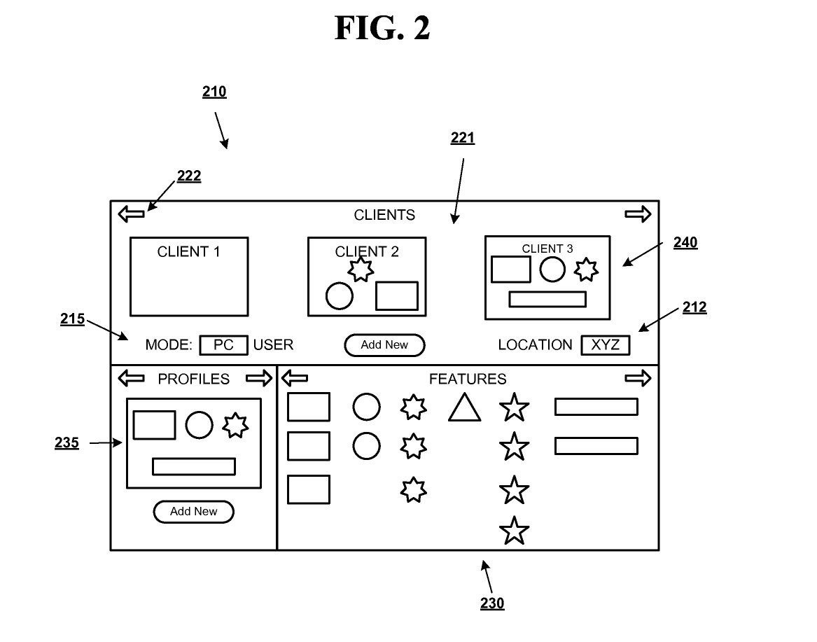

FIG. 2 shows an example of the client license interface 110 described with reference to FIG. 1 according to an embodiment of the invention. In the example, a primary location screen 210 shows the clients 150 and/or user accounts at a particular location, business unit, or enterprise. The screen 210 of the interface 110 may include a hierarchy identifier 212 to indicate the particular location, business unit, enterprise, or relative location of the current clients or user accounts within the overall license hierarchy of an enterprise. In some embodiments, the interface shown may adapt to illustrate all the clients 150 within a particular business unit, geographic location, or other division of an enterprise, or the entire enterprise.

A client mode selector 215 may allow the administrator 160 to select or define the type of “client” 150 being considered within the interface 110. For example, the administrator 160 may be able to select “PC” or “USER” clients 150. In a PC-related interface, the “clients” 150 represent individual computers or other hardware-based resources that may be configured by the license abstraction server 100. In an account (USER)-related interface, the “clients” 150 represent user accounts that may be configured by the license abstraction server 100 such that they provide the same software features regardless of which individual computer or hardware-based resource the user accesses to use his account.

A client listing 221 may provide a graphical depiction of clients 150 available for configuring within the license abstraction server 100. In the example, the listing 221 can be scrolled horizontally, but it will be understood that various other arrangements may be used, including graphical lists, trees, geographical or logical maps, and the like. The client listing 221 may be responsive to the client mode selector 215 to behave accordingly, i.e., if the client mode selector 215 is in PC mode, listing 221 depicts available hardware resources, whereas if the client mode selector 215 is in a user mode, the listing 221 depicts available user profiles to configure. The interface 110 may provide various user controls 222 to allow an administrator to display and configure other hardware resources and/or user accounts. The interface 110 also may provide user controls to allow for manual input or other selection of a specific client number or identifier, a specific user account, or a group of computers or user accounts not currently displayed, such as an identifier search control.

A feature listing 230 may provide a list or visual depiction of discrete software packages, software features, or combinations thereof that are available to be pushed out to one or more clients 150. In the example, software features are arranged as graphical shapes in columns that can be scrolled horizontally. In the case of the first column (rectangles), there are three such features, or three licenses for the identical feature, available. In the case where there are more of a particular type of feature than can reasonably displayed, a numerical or other indication of the total number available also may be shown. Other techniques, such as lists, trees, icons, or other textual or visual indications of the available software features may be used.

The screen 210 may include a profile listing 235. Profiles of feature sets may be defined that can be used as templates to configure remote clients 150. For example, in the illustrated interface, Client 3 240 is configured with the profile shown in the listing 235. The use of profiles may allow, for example, a series of similar clients 150 (computers or user accounts) to be configured with the same set of features, such as where all staff computers in an enterprise need to be configured with the same software packages or features. The interface may be graphically-based, such that the administrator 160 can configure a specific client 150 by selecting and dragging features or a profile onto the client 150 or account to be configured. For example, to configure Client 1 with the same features as Client 3, the administrator 160 may drag the profile illustration 235 onto the representation of Client 1 in the client listing 221. The features included in the profile then may be pushed to the Client 1 account or device as a configuration for that client 150. Combinations of profiles and other features may be used, for example by configuring a client 150 with a feature profile initially, then adding or removing software packages or features as desired. As features are used, either by way of a profile or individually, the feature list 230 may be updated to show that the used features are no longer available to configure other clients 150.

After the set of features desired for one or more clients 150 has been defined, a configuration file, and/or installation files may be generated by the server 100 and pushed to the client 150. As described above, the client may be either hardware, such as a particular computer, a user profile that is hardware-independent and follows a specific user upon whichever hardware that user may log-on, or a combination thereof. The client configuration may be pushed to the appropriate client(s) 150 based upon any suitable occurrence or rule. For example, a client configuration may be pushed to a client 150 according to a schedule, it may be activated upon a start of a configured software application, it may be activated upon log-on of a user to a computer, or it may be provided ad-hoc.

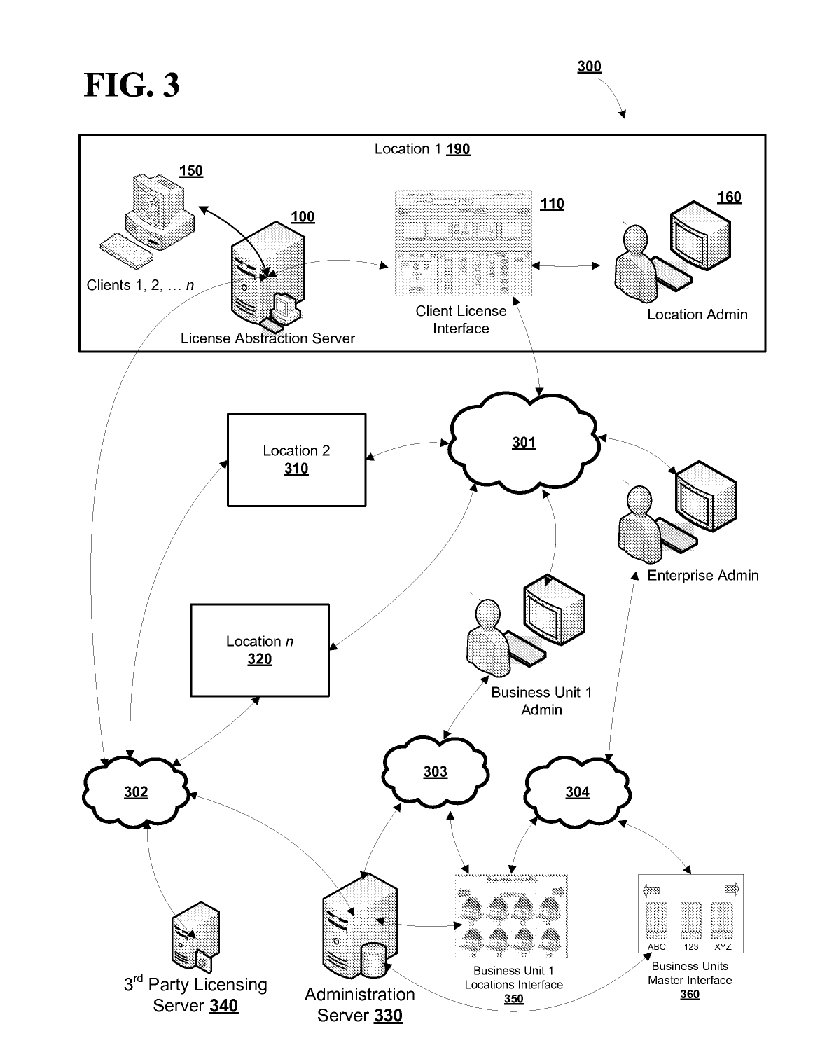

FIG. 3 shows a hierarchical system 300 for license abstraction and management according to an embodiment of the invention. The system may include multiple locations 190, 310, 320, each of which may include some or all of the components previously described with respect to FIG. 1. For example, each location 190, 310, 320 may include multiple clients 150, a license abstraction server 100, and a client license interface 110. In some configurations, a central license abstraction server 100 and/or a common client license interface 110 may be used for multiple locations 190, 310, 320. Generally, the locations 190, 310, 320 may be any logically or geographically separate division of an enterprise, such as business units, physical offices, subsidiaries, or any similar division or combinations thereof. Each location 190, 310, 320 may include a license abstraction server 100 as previously described, to generate licensed software configurations for clients at the location 190, 310, 320. The license abstraction servers 100 at each location may in turn receive one or more licenses from a license abstraction server higher in the hierarchy. For example, an enterprise-level license abstraction server 330 may provide licenses to software packages or features to one or more license abstraction servers 100 at various other locations 190, 310, 320. An arbitrary number of hierarchy levels may be used and, in general, licensed software packages and/or features may be arbitrarily pushed to each license abstraction server 100. As a specific example, an enterprise-level abstraction server 330 may push licenses and/or other configuration data to business unit abstraction servers, such as may be located at Location 2 310, for example. Each business unit abstraction server may in turn push licenses and/or other configuration data to one or more office-level abstraction servers 100, which then push license configuration data to clients 150 for which they are responsible. As another example, an enterprise-level abstraction server 330 may manage all clients within the enterprise, without using business unit, office, or other levels of abstraction servers.

The abstraction system(s) may interface with one or more third-party licensing servers 340 as are known in the art. Such servers typically provide conventional license management for a particular type of license, a license system from a particular vendor, a unified set of related software licenses, or the like. By themselves, the third-party licensing servers do not provide any abstraction or push capabilities as described herein. Rather, they serve as a source of licenses that can be managed, abstracted, and pushed in whole or in part by the license abstraction server 100 to clients as described herein.

A variety of user interfaces may be used to manage the different hierarchy levels in the system. For example, a location interface 350 may allow an administrator to select and manage multiple locations within a single business unit of the enterprise. Similarly, a master business unit interface 360 may allow an administrator to select a business unit or other higher-level subdivision of the enterprise for license management. The interfaces 350, 360 may be integrated with the more local client license interface 110, such that an administrator can “drill down” to a desired hierarchy level and manage licenses at clients for which the selected level of administration server is responsible.

More generally, the software used in conjunction with and to implement the license abstraction systems described herein may include a hierarchy of permissions that allow access to various levels of the system. Generally, each software component may reside within a separate environment, or it may be combined with other components. In an embodiment, a location administration interface 350 may abstract location-level software licenses and license features. It may include or communicate with a location administration database and/or an enterprise administrative database to store license data for clients managed by or within the location administration hierarchy.

In an embodiment, one level higher than the location administration hierarchy level is a business unit administration hierarchy level, the functionality of which may be administered via the business unit administration interface 360. In this configuration, each business unit includes multiple locations, each of which includes multiple clients. A client may be managed from a local, location, or business unit level.

In an embodiment, one level higher than the business unit administration hierarchy level is an enterprise administration hierarchy level, which may be provided by the enterprise administration server 330. Such an interface may provide access to the other interfaces 110, 350, 360 throughout the entire enterprise. It also may allow an administrator to traverse the entire hierarchy, configuring clients at any level via the appropriate interface 110, 350, 360. In this manner, the enterprise administration server 330 acts as a “parent” license abstraction server to the “children” license abstraction servers at lower relative hierarchical levels. In some embodiments, a parent license abstraction server may directly administer to clients served by its child license abstraction servers. In other embodiments, a parent license abstraction server may redistribute available license features among its child servers for administration thereby.

In an embodiment, each interface 110, 350, 360 may be provided by one or more servers or other computer systems that require the same permission to operate as the associated interface. For example, a system may include a local administration server 100, a business unit administration server (not specifically shown), and/or an enterprise administration server 330.

The different components of the system may be connected by, and communicate using, one or more networks 301, 302, 303, 304. The network(s) may be internal networks, private networks, or wide-area networks, the Internet, or various combinations thereof. Unless specifically indicated otherwise, any type and topology of network may be used to connect the components, as will be understood by one of skill in the art.

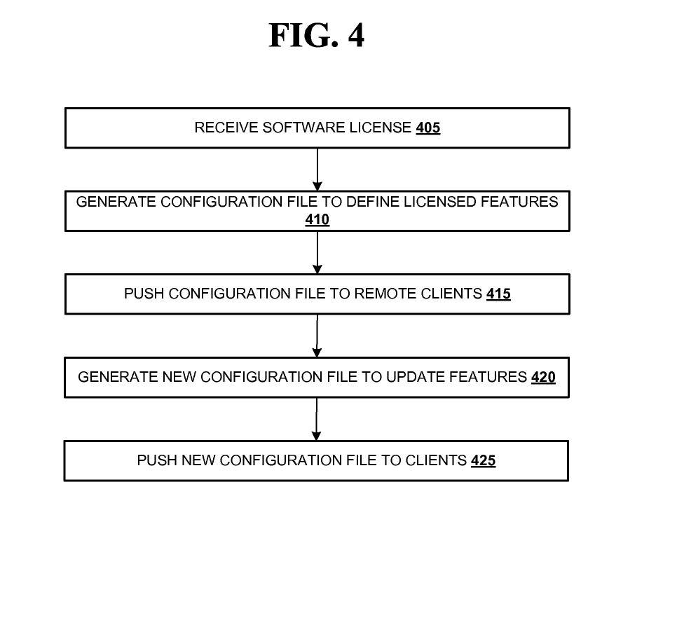

FIG. 4 shows a flowchart of an exemplary license abstraction technique. At process step 405, a central license abstraction server 100 may receive a software license that defines rights for a licensed software package. At process step 410, responsive to an instruction from a license administrator 160, a configuration file may be generated that defines a first set of features allowed for client use, including features available in the first licensed software package, for deployment at one or more remote clients 150. At process step 415, the configuration file may be pushed from the central license abstraction server 100 to one or more remote clients 150, to cause the remote clients 150 to provide the first set of features to users of the remote clients 150. At step 420, based upon an instruction from an administrator 160, a new configuration file may be generated to define a second set of features based upon features available in the licensed software package. In general, the total features defined by the first and second sets of features does not extend beyond the terms of the software license received at process step 405. At process step 425, the new (second) configuration file may be pushed to the remote clients, to cause the remote clients to provide the new (second) set of features.

It will be understood that variations of the specific techniques shown in FIG. 4 may be used. For example, one or more clients 150 may be configured, and each client 150 may be configured according to a different configuration file, and various hierarchies of license features may be used as described herein.

In embodiments of the license abstraction systems described herein, license configurations may be pushed to clients 150 from one or more administrative systems 190, 300. Compared to traditional pull systems, this may provide enhanced security and efficient resource management, as well as reduced repair activities.

Further, known pull methods are usually administered locally, i.e., at each individual client, by a super-user account. In systems where some degree of central configuration is available, such as standardized software installation and user account administration, a relatively high degree of expertise is required for a user to administer client software and license configuration. In contrast, the systems described herein provide the ability for a supervisor with minimal technical expertise to graphically administer client license configuration and distribution. The ability of the present systems to extend to multiple management levels also provides a hierarchical view of an enterprise's licensing landscape not previously available in known management systems. The ability to centrally configure and push features to multiple clients, locations, and business units affords a central administrator the ability to assign and use limited features and/or licenses in a most productive manner, such as to provide to clients features and/or licenses that are urgently needed to perform high priority tasks.

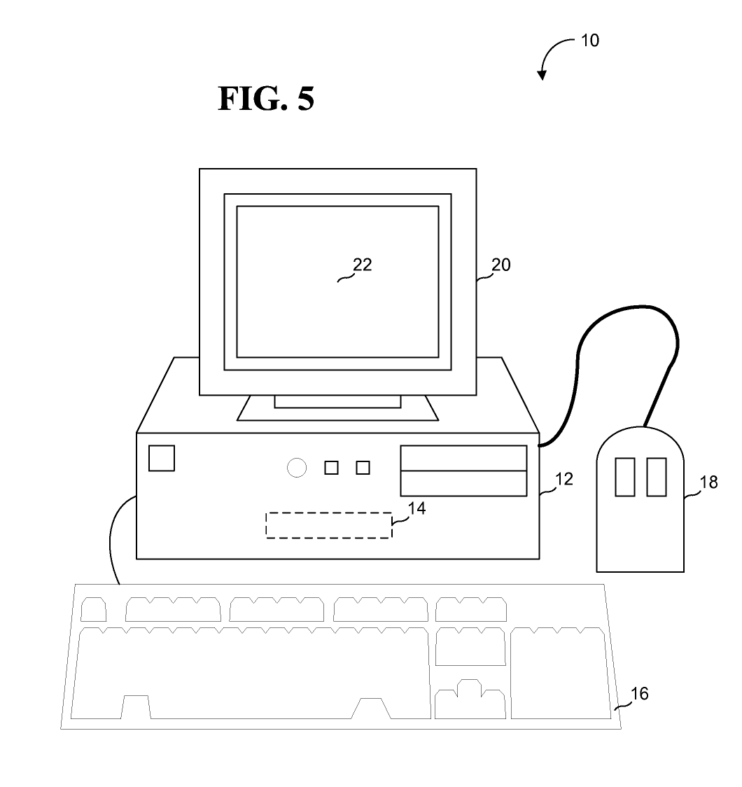

FIG. 5 shows a computer 10 suitable for use with embodiments of the present invention. The computer 10 may include a processing unit 12, which may include one or more computer readable storage media 14. The computer 10 may interface with a human operator via an output 20, which may include a visual display 22 to display text, graphics, video, and other visual data. The computer may receive input via a mouse 18, keyboard 16, and/or any other suitable user interface. The general operation of the computer 10 will be understood to one of skill in the art.

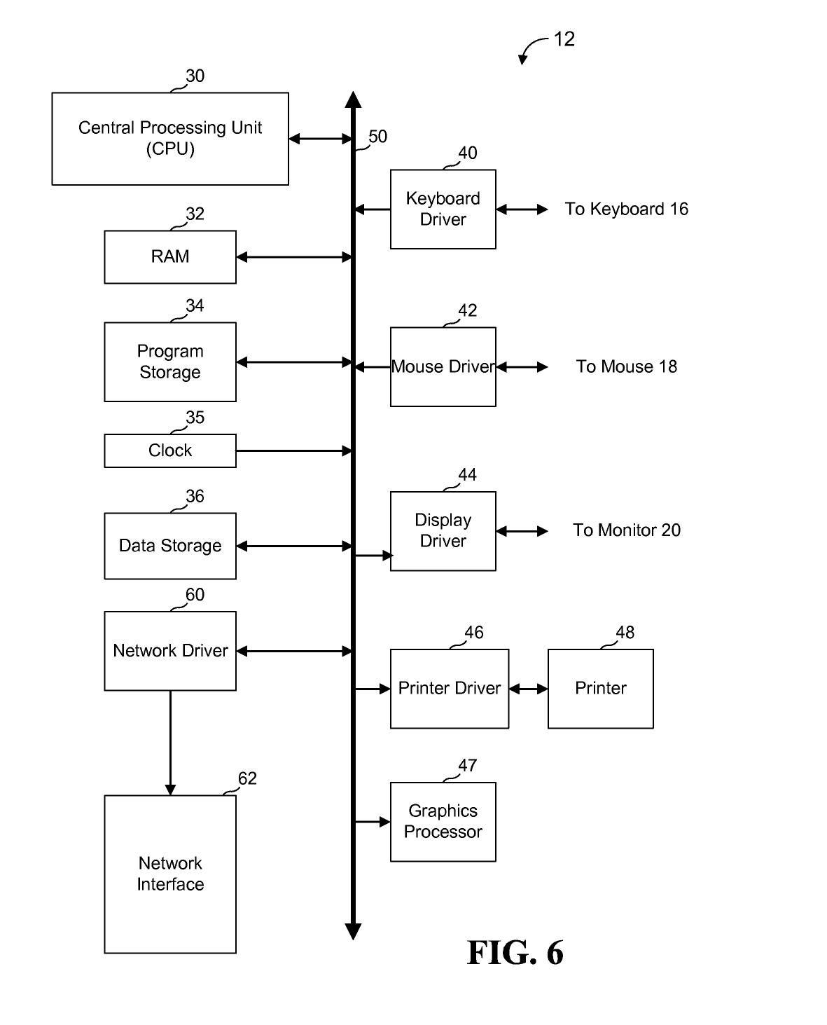

FIG. 6 shows a schematic diagram of the processing unit 12. A central processing unit 30 may communicate with various other components via a main bus 50 and other suitable communication lines (not shown). Data may be stored in volatile memory such as RAM 32, program storage 34 and/or data storage 36. The program storage 34 and/or data storage 36 may include various types of computer-readable media, such as CD-ROMs or other type of optical disks, floppy diskettes, ROMs, RAMs, EPROMs, EEPROMs, magnetic or optical cards and drives, flash memory, or other types of machine-readable mediums suitable for storing electronic instructions. Computer-readable instructions may be stored in the program storage 34. When executed by the computer, these instructions may cause the computer to implement specific methods as described herein, and may cause the computer to operate in accordance with those methods. In an embodiment, execution of the instructions stored in the program storage 34 may transform a general-purpose computer into a computer configured to perform one or more methods embodied by the instructions. A clock 35 may be used to synchronize operation of the other elements of processing unit 12. A network driver 60 may manage connections between a network interface 62, such as a TCP/IP or other suitable interface, to allow the computer 10 to communicate with other computers, operators, or other entities. A keyboard driver 40 may communicate with the keyboard 16 to receive input from an operator. A mouse driver 42 may manage communication with the mouse 18 to coordinate reception of input signals. A display driver 44 may manage communications between the processing unit 12 and the monitor 20, such as to display appropriate output on the monitor 20. Similarly, a printer driver 46 may manage communications with a printer 48. A graphics processor 46 may generate and manage manipulation and display of graphical elements such as 2D images, 3D images and objects, and other visual elements. The general operation of the various components shown in FIG. 5 otherwise will be understood by one of skill in the art.

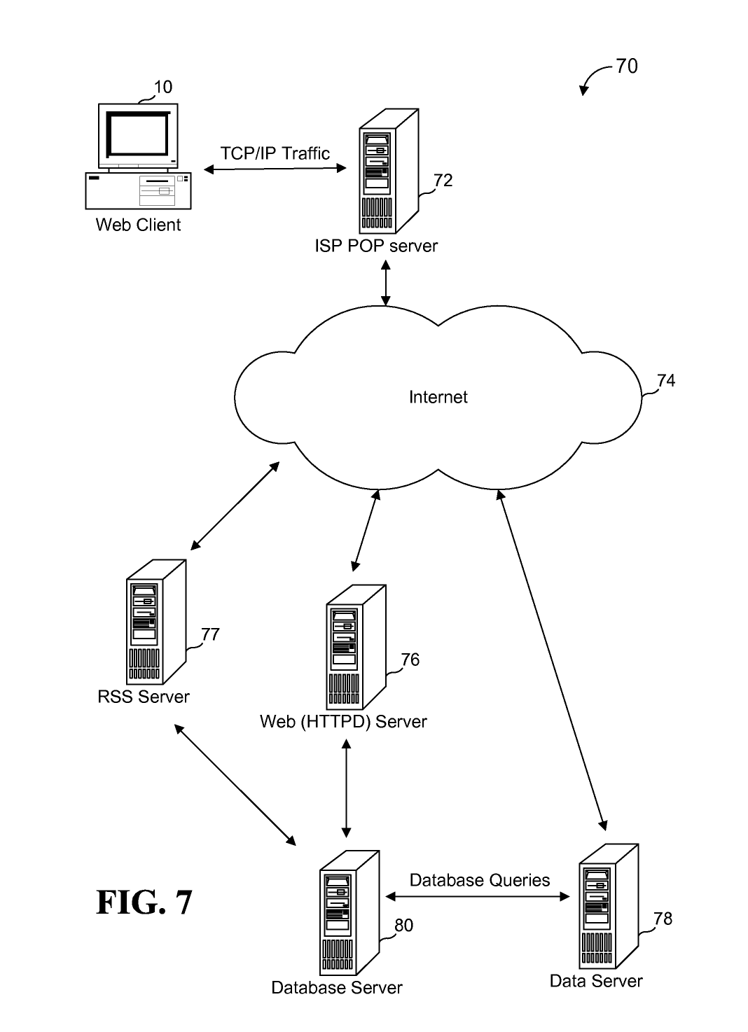

FIG. 7 shows an example of a computer network 70 suitable for use with the present invention. A client such as the computer 10 may access the Internet or other network via a point of presence server 72 or other server, such as provided by an ISP. The computer 10 may access various servers, such as a web or HTTP server 76, an RSS server 77, or other suitable server or other information provider. As previously described, the various computers 10, 76, 77 may communicate with one or more databases 80 or other data servers 78 to retrieve information. The general operation of the network 70 and the various components shown in FIG. 7 otherwise will be understood by one of skill in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein.

Particular methods, devices, and materials are described, although any methods and materials similar or equivalent to those described herein can be used in the practice or testing of the invention. All references referred to herein are incorporated by reference herein in their entirety.

Various embodiments of the invention may include or be embodied in the form of computer-implemented processes and apparatuses for practicing those processes. Embodiments also may be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments of the invention also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with the present invention in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the present invention.

Examples provided herein are merely illustrative and are not meant to be an exhaustive list of all possible embodiments, applications, or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the relevant arts or fields are intended to be within the scope of the appended claims. It is to be noted that as used herein and in the appended claims, the singular forms “a,” “an,” and “the” include the plural reference unless the context clearly dictates otherwise.

The disclosures of all references and publications cited above are expressly incorporated by reference in their entireties to the same extent as if each were incorporated by reference individually.

What is claimed is:

1. A method comprising:
at a central license abstraction server, receiving a first software license, the first software license defining rights for a first licensed software package;
responsive to an instruction from a license administrator, generating a first configuration file that defines a first set of features allowed for client use, the first set of features including features available in the first licensed software package, for deployment at a plurality of remote clients;
pushing the first configuration file from the central license abstraction server to the plurality of remote clients to cause the remote clients to provide the first set of features to users of the remote clients;
responsive to an instruction from a license administrator, generating a second configuration file that defines a second set of features allowed for client use, the second set of features including features available in the first licensed software package, wherein the total features defined by the first and second sets of features do not extend beyond the terms of the first license; and
pushing the second configuration file to the remote clients to cause each of the remote clients to provide the second set of features to users of that client.

2. A method comprising:
at a central license abstraction server, receiving a first software license, the first software license defining rights for a first licensed software package;
responsive to an instruction from a license administrator, generating a first configuration file that defines a first set of features allowed for client use, the first set of features including features available in the first licensed software package, for deployment at a first remote client; and
pushing the first configuration file from the central license abstraction server to the first remote client to cause the first remote client to provide the first set of features to a user of the first remote client.

3. The method of claim 2, further comprising:
responsive to an instruction from a license administrator, generating a second configuration file that defines a second set of features allowed for client use, the second set of features including features available in the first licensed software package, for deployment at a second remote client, wherein the total features defined by the first and second sets of features do not extend beyond the terms of the first license; and
pushing the second configuration file to the second remote client to cause the second remote client to provide the second set of features to a user of the second remote client.

4. The method of claim 3, wherein the second set of features includes at least one feature from the first set of features.

5. The method of claim 3, further comprising the step of pushing the second configuration file to a plurality of remote clients to cause each of the plurality of remote clients to provide the second set of features to a user of that client.

6. The method of claim 2, further comprising:
subsequent to the step of pushing the configuration file to the first remote client, generating a second configuration file that defines a second set of features encompassed by the first license for deployment at the first remote client; and
pushing the second configuration file to the first remote client to cause the first remote client to provide the defined second set of features to a user of the first remote client.

7. The method of claim 2, wherein the received first software license is a sub-portion of a parent license, and is pushed to the central license abstraction server by a parent license abstraction server.

8. The method of claim 2, wherein the first software license is received from a third-party license management system.

9. The method of claim 2, further comprising the step of receiving a second software license, the second software license defining rights for a second licensed software package;
wherein the first set of features includes features available in the second licensed software package.

10. The method of claim 9, wherein the first software license is received from a third-party license management system.

11. The method of claim 2, further comprising the step of pushing the first configuration file to a plurality of remote clients to cause each of the plurality of remote clients to provide the first set of features to a user of that client.

12. The method of claim 2, wherein the first remote client comprises a hardware-based resource.

13. The method of claim 2, wherein the first remote client comprises a user account that provides the first set of features to any hardware-based resource accessed by the user.
